(19) United States
(12) Patent Application Publication
(10) Pub. No.: US 2008/0250815 A1
(43) Pub. Date: Oct. 16, 2008

(54) LifeLinks(TM) - multi directional and combinational personalized jewelry system

(76) Inventors: Glenn Matthew Wachler, Charlevoix, MI (US); Lincoln Grant Wachler, Troy, MI (US)

Correspondence Address: GLENN M. WACHLER, 217 BELVEDERE AVE., CHARLEVOIX, MI, 49720, US

(21) Appl. No.: 12/075,074

(22) Filed: Mar. 6, 2008

Related U.S. Application Data
(60) Provisional application No. 60/923,181, filed on Apr. 13, 2007.

(51) Int. Cl. A44C 13/00; G06Q 30/00

(52) U.S. Cl. 63/1.15; 63/1.14; 705/14

(57) ABSTRACT

The invention relates to a combination of modular parts that can be worn and utilized in a multitude of ways. The user can manually configure and reconfigure the parts to meet their needs at the point of use with the temporary locking system.

The Invention, LifeLinks™-Multi Directional and Combinational Personalized Jewelry System is a Non Provisional patent application claiming the benefit of provisional application dated Apr. 13, 2007 with Application No. 60/923,181. Inventors: Glenn M. Wachler and Lincoln G. Wachler

### BACKGROUND OF THE INVENTION

As long as people have walked the Earth they have ornamented themselves. Their desire of personalized expression continues today. Being able to take a few items and express them in multiple ways gives today's consumer and stores the ability to spend less and have more.

A few inventions have been made that relate to wearing ornamentation in different configurations. Examples of these are found in U.S. Pat. No. 7,322,213, a friction based method of combining ornamentation parts, U.S. Pat. No. 4,034,573, an ornament which consists of two changeable chain-like elements, U.S. Pat. No. 6,032,486, a reversible earring, U.S. Pat. No. 6,789,395, a pendant necklace which is convertible to three different geometric configurations and U.S. Pat. No. 6,880,364, a bracelet with exchangeable decorative loop members. However, such prior jewelry and ornamentation pieces and those similar in the prior art fail to provide for the modification and resulting versatility of the present invention, which offers many more options to the user and at the same time provides a secure temporary locking system.

### SUMMARY OF THE INVENTION

It is thus the object of the present invention to overcome the limitations and disadvantages of existing modifiable jewelry and ornamentation. LifeLinks is a system based on a collection of standard sized units that can be combined in different combinations and orientations to create a multitude of jewelry and ornaments. The utility is demonstrated as the combinations and orientations of the parts allow a person to personalize their ornamentation utilizing a temporary locking system designed into the product system. The modular design maximizes the ability to personalize the look of the ornamentation at the point of use. The utility is further enhanced because stores offering LifeLinks can now stock fewer items while being able to present more choices to the consumer. Consumers can purchase fewer items and still maximize the potential wearable opportunities.

### BRIEF DESCRIPTION OF THE DRAWINGS

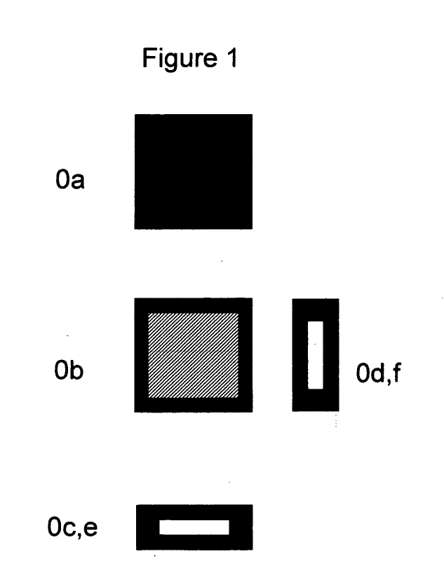

Drawing 1 depicts FIG. 1—views of a LifeLink.

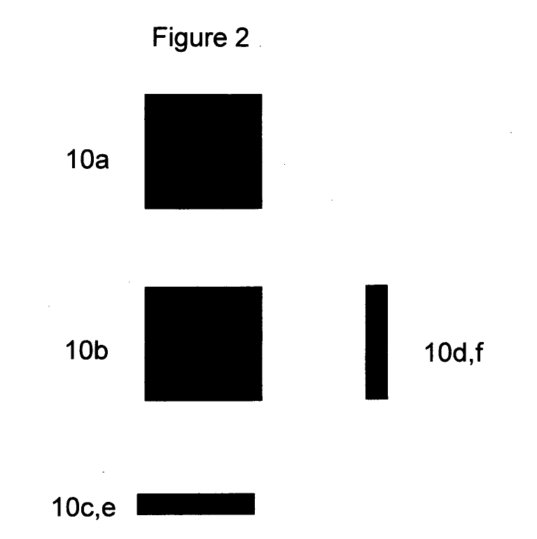

Drawing 2 depicts FIG. 2—views of a LifeLink Tile.

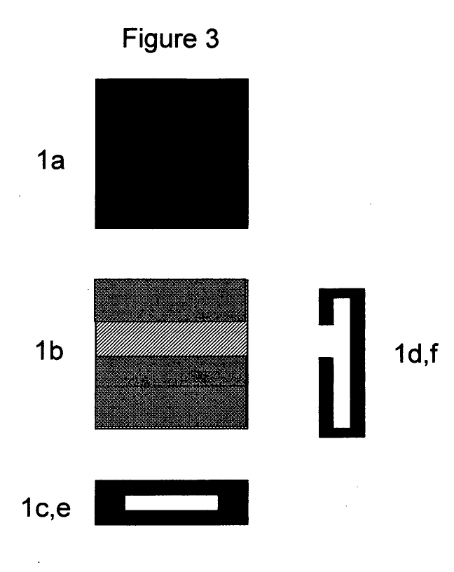

Drawing 3 depicts FIG. 3—views of a LifeLink Clip and Slide.

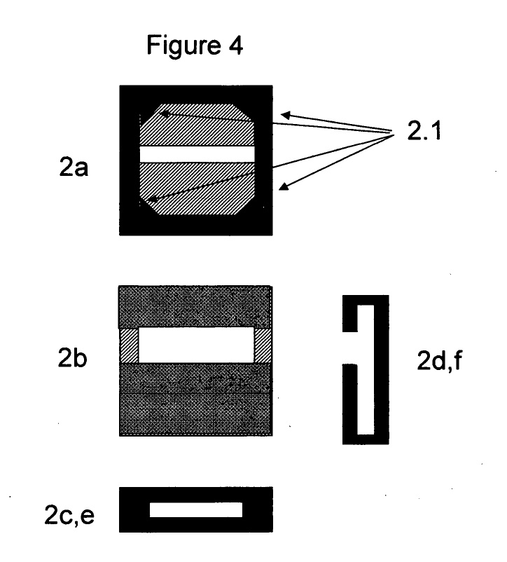

Drawing 4 depicts FIG. 4—views of a LifeLink Clip and Slide Frame.

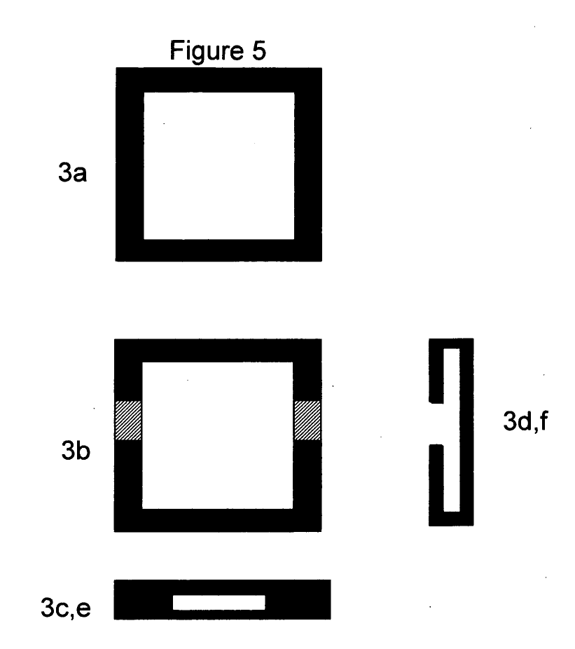

Drawing 5 depicts FIG. 5—views of a LifeLink Clip and Slide Frame Frame.

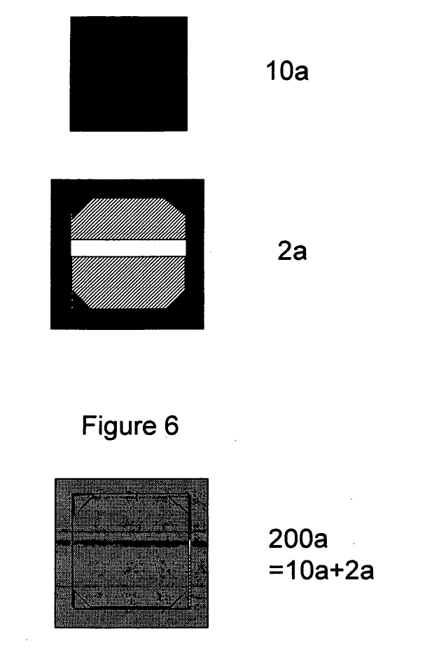

Drawing 6 depicts FIG. 6 shows how two parts combine to make a completed LifeLink Clip and Slide Frame.

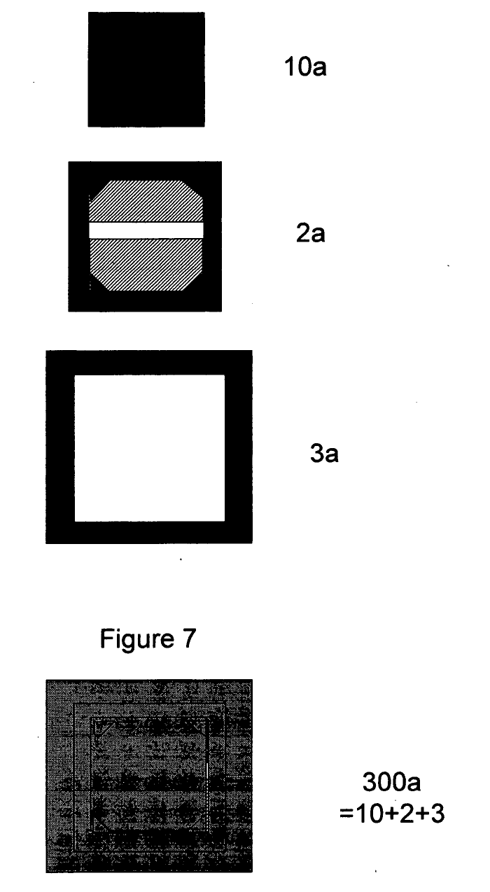

Drawing 7 depicts FIG. 7 shows how 3 parts combine to make a LifeLink Clip and Slide Frame Frame.

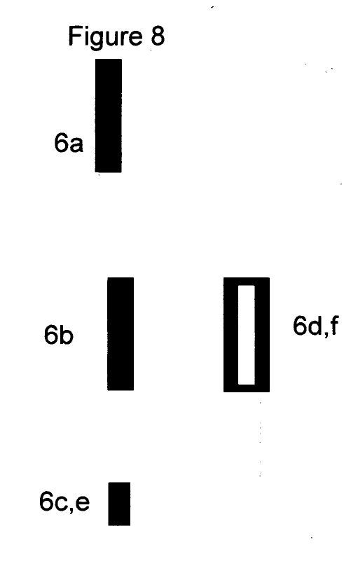

Drawing 8 depicts FIG. 8—views of a LifeLink Spacer.

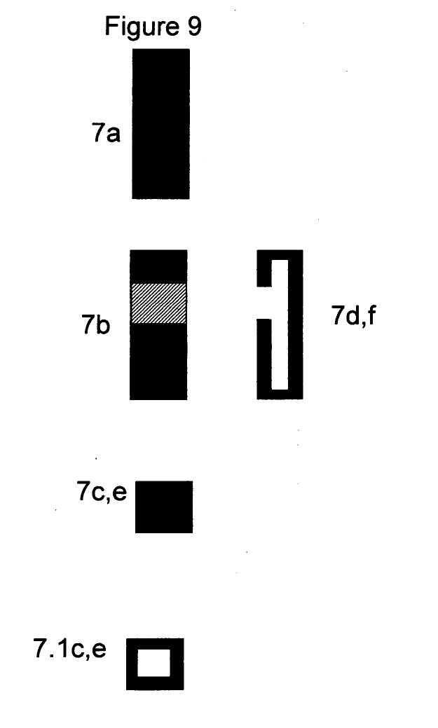

Drawing 9 depicts FIG. 9—views of a LifeLink Clip and Slide Spacer (2 versions).

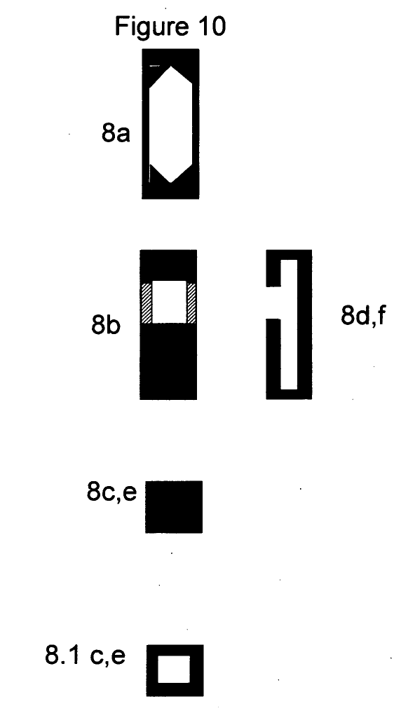

Drawing 10 depicts FIG. 10—views of a LifeLink Clip and Slide Spacer Frame (2 versions).

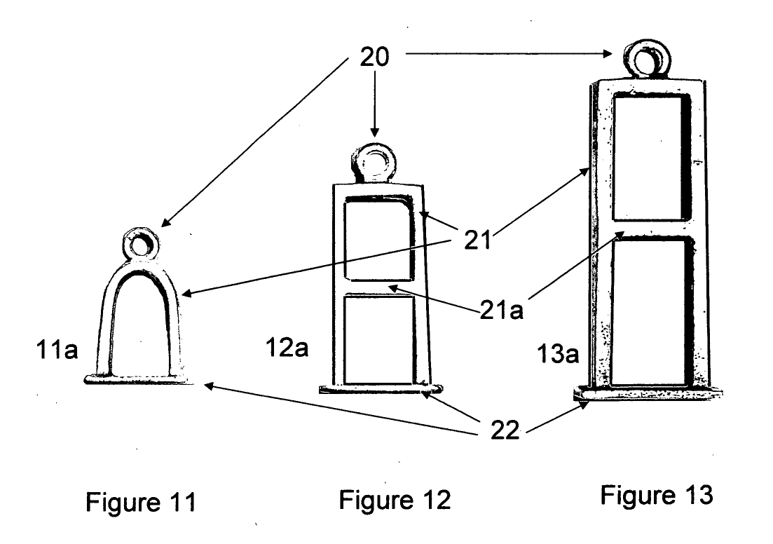

Drawing 11 depicts the characteristics of FIG. 11 Charm Adapter, 12 Frame Adapter, and 13 Frame Frame Adapter.

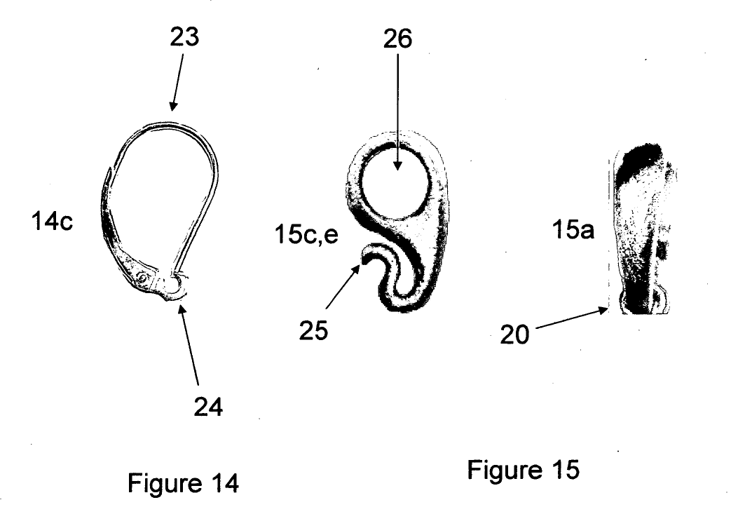

Drawing 12 depicts the characteristics FIG. 14 Lever Back earring adapter, and FIG. 15 Linker.

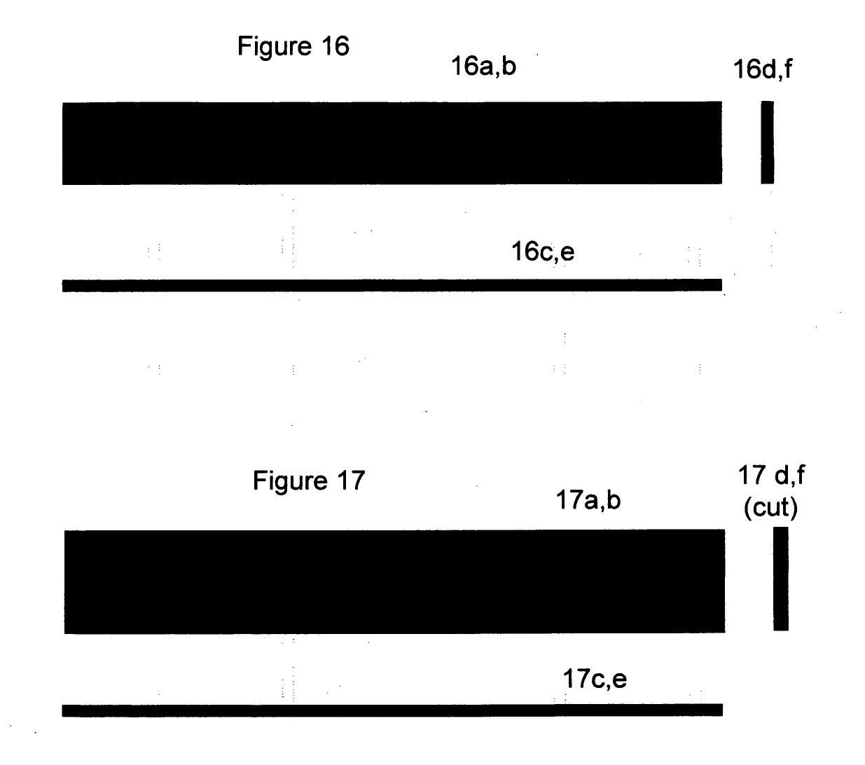

Drawing 13 depicts the views of FIG. 16 non continuous and FIG. 17 continuous rubber or other material that allow parts to be put on them.

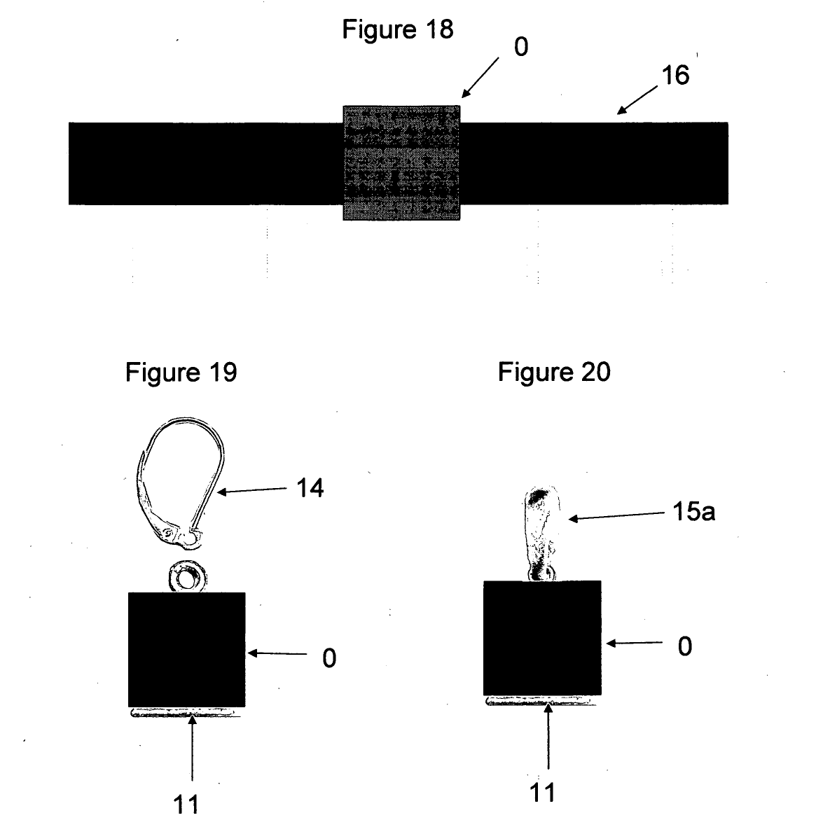

Drawing 14 demonstrates how the combination of parts turns into jewelry FIG. 18 LifeLink on a non continuous bracelet. FIG. 19 LifeLink as an earring and FIG. 20 LifeLink as a pendant.

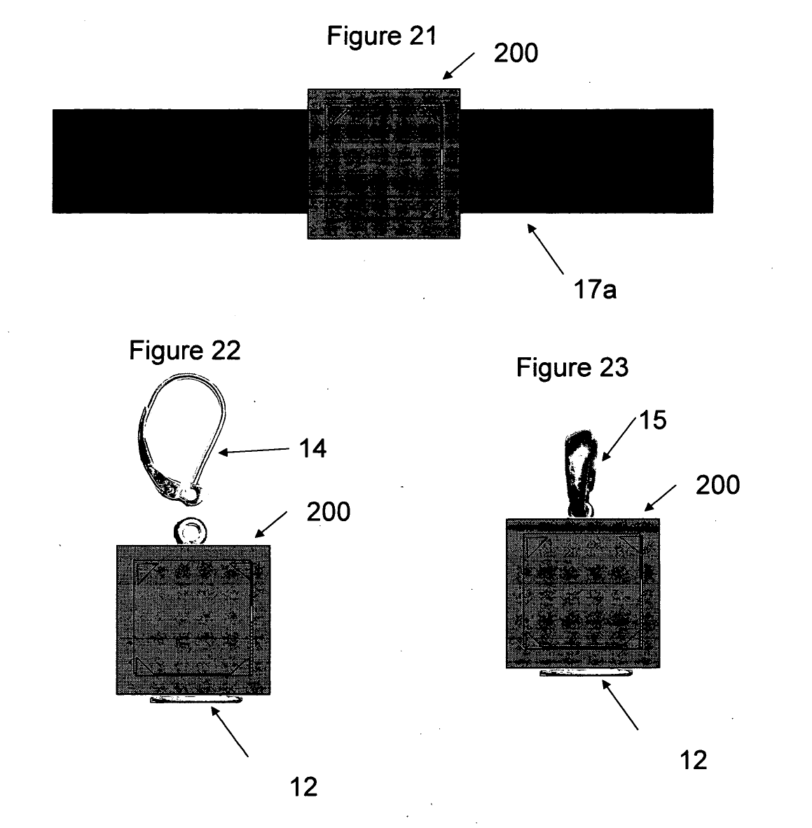

Drawing 15 demonstrates how the combination of parts turns into jewelry FIG. 21 completed LifeLink Clip and Slide Frame on a continuous bracelet, FIG. 22 completed LifeLink Clip and Slide Frame as an earring. FIG. 23 completed LifeLink Clip and Slide Frame as a pendant.

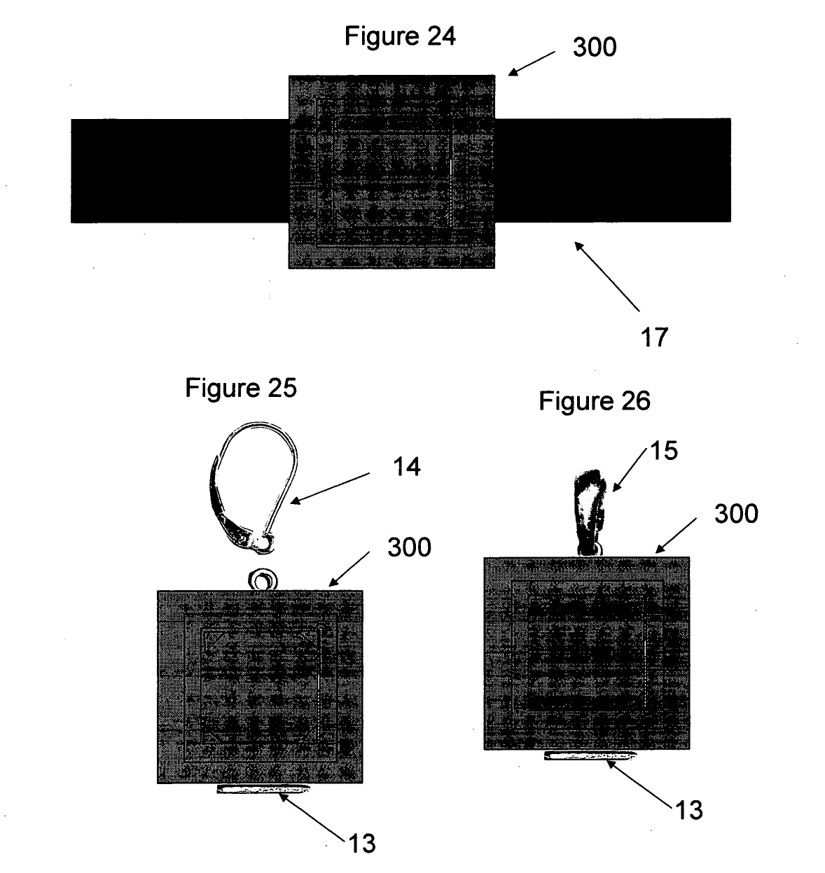

Drawing 16 demonstrates how the combination of parts turns into jewelry FIG. 24 completed LifeLink Clip and Slide Frame Frame on a continuous or non continuous bracelet. FIG. 25 completed LifeLink Clip and Slide Frame Frame as an earring. FIG. 26 completed LifeLink Clip and Slide Frame Frame as a pendant.

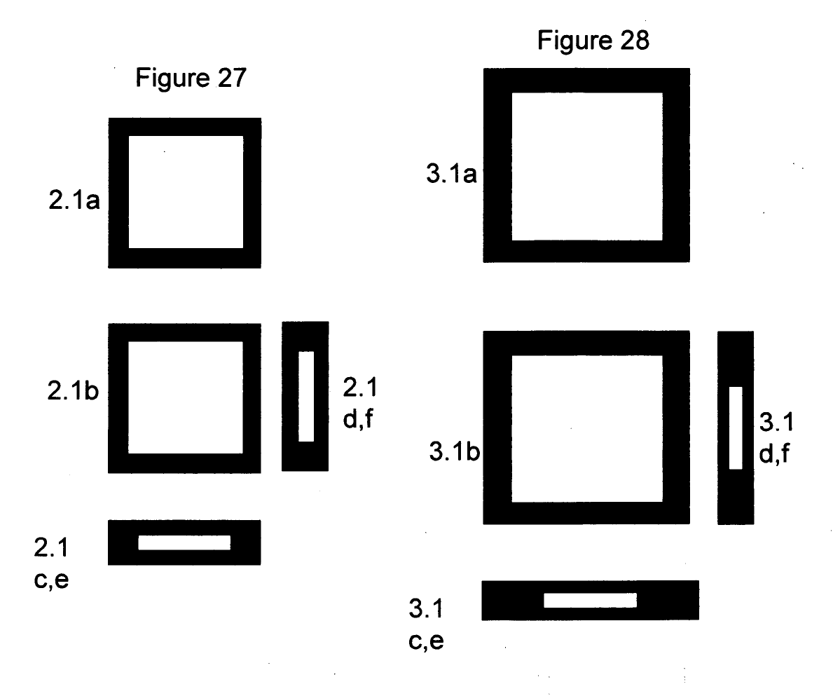

Drawing 17 depicts views of FIG. 27 LifeLink Frame for use with non continuous material and views of FIG. 28 LifeLink Frame Frame for use with non continuous materials.

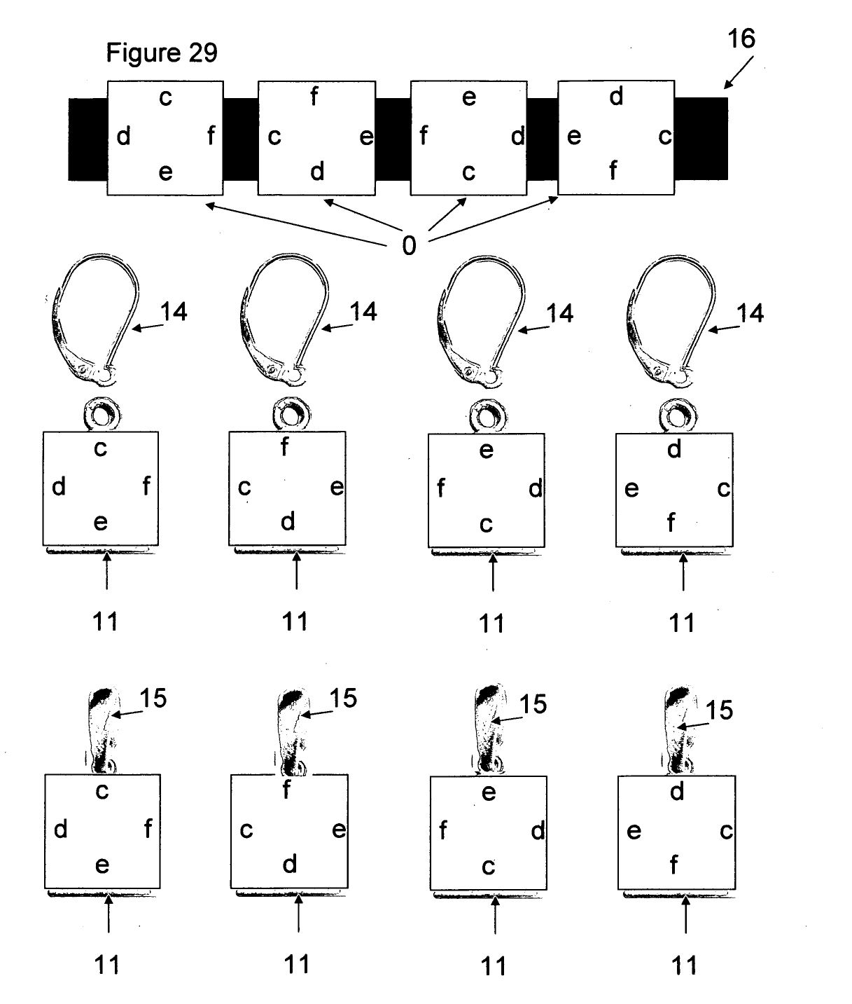

Drawing 18 depicts FIG. 29 demonstrating a LifeLinks modular design in several pieces of ornamentation.

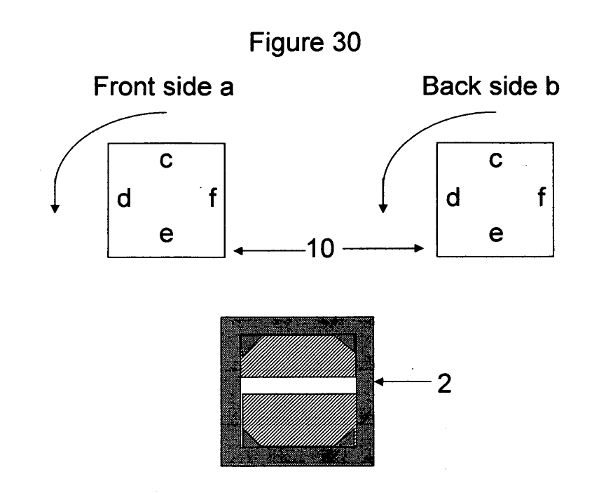

Drawing 19 depicts FIG. 30 which demonstrating a LifeLink Tiles modular design as an ornamentation.

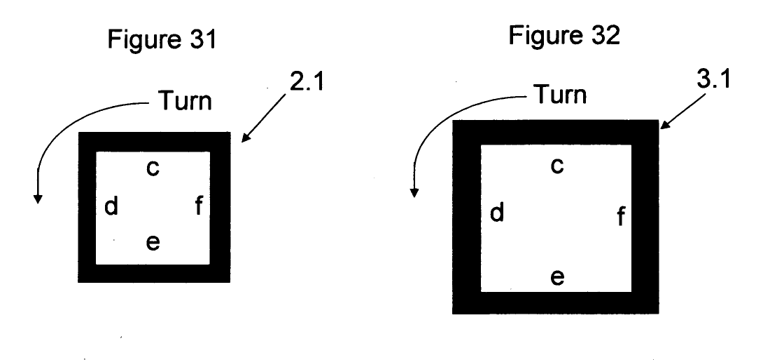

Drawing 20 depicts the modular design of FIG. 31 LifeLink Frame and FIG. 32 LifeLink Frame Frame.

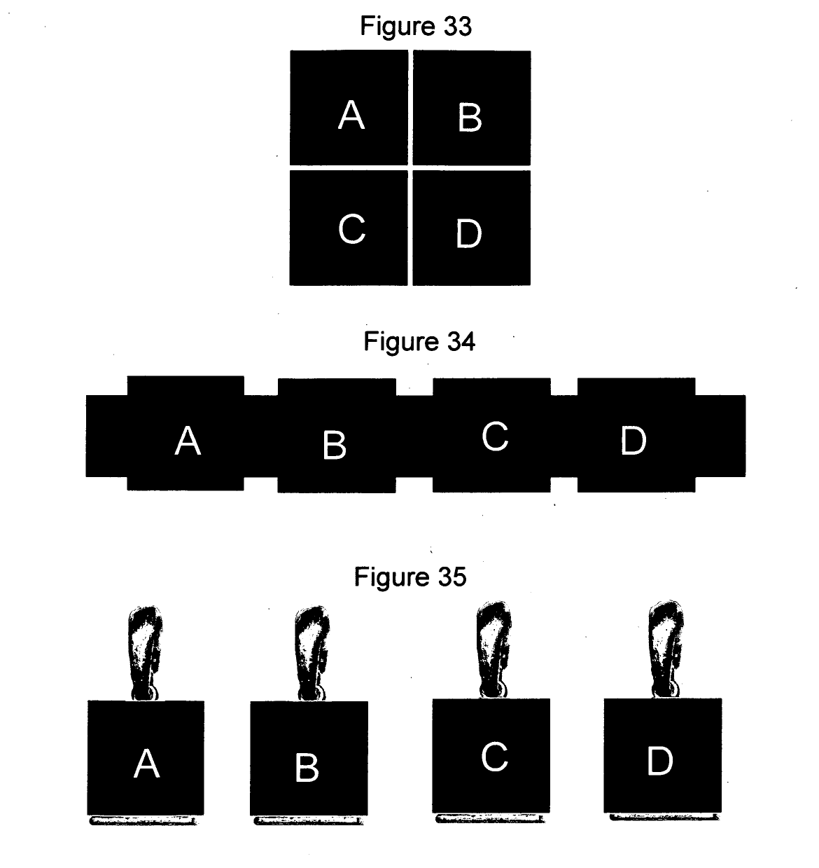

Drawing 21 depicts FIG. 33 LifeLinks puzzles can be separated to be FIG. 34 pieces on a single item or FIG. 35 pieces on 4 individual items. LifeLink Tiles can also be designed as puzzles.

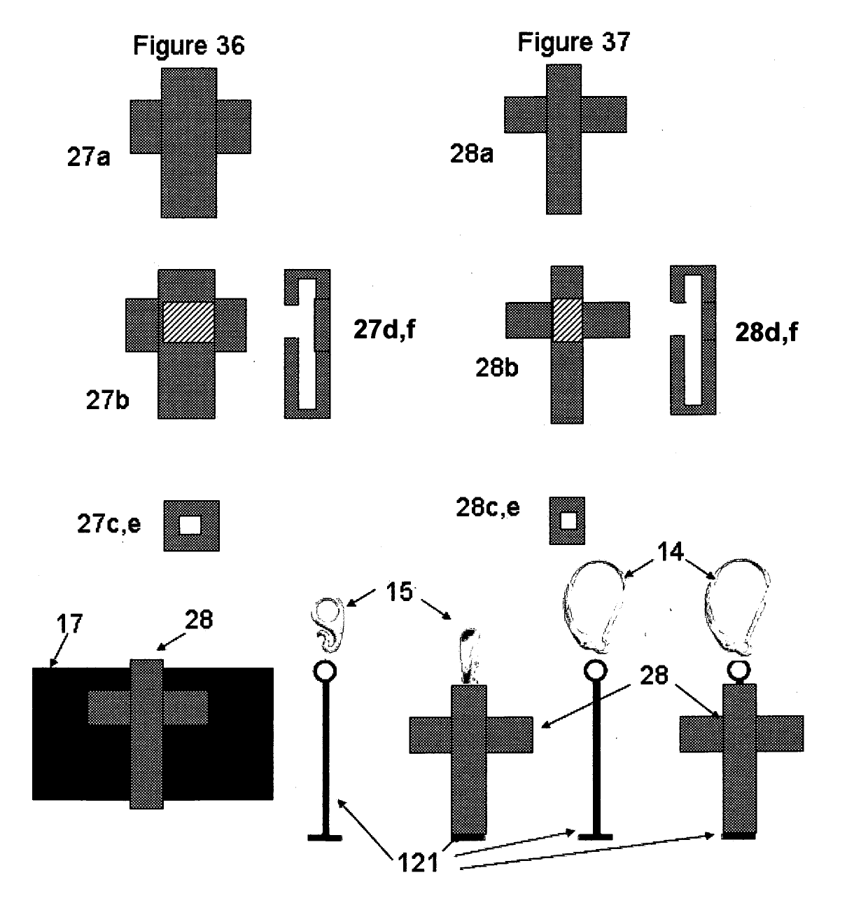

Drawing 22 depicts cross shapes of FIG. 36 and FIG. 37

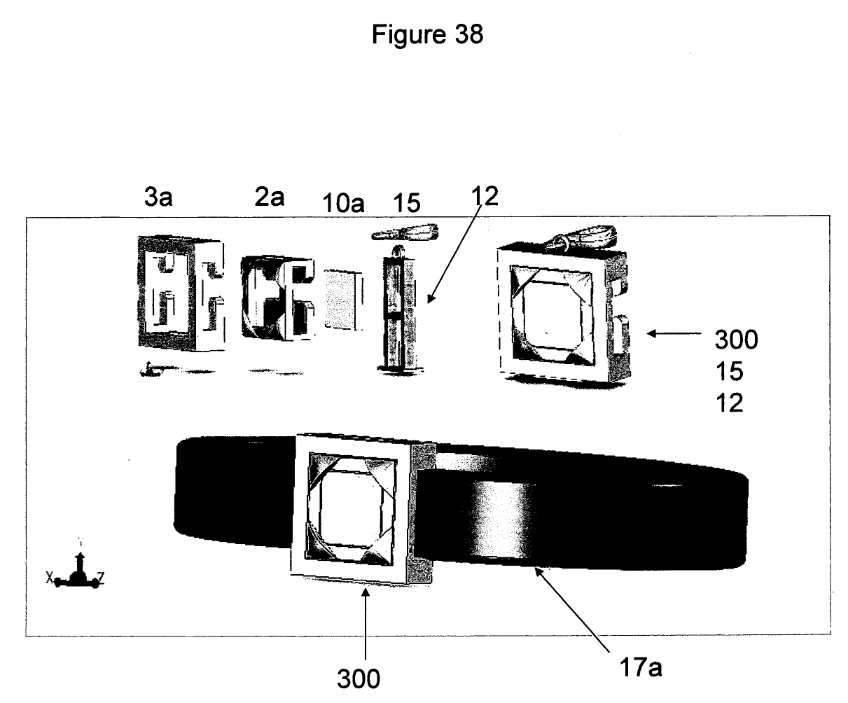

Drawing 23 depicts FIG. 38 which shows a 3 dimensional view for clarification.

### DETAILED DESCRIPTION OF THE INVENTION

In a first aspect, the invention provides a system of ornamentation utilizing a combination of modular parts that when combined with continuous or non continuous bracelet material and adapters becomes an unlimited combination of jewelry. The LifeLinks™ system allows the consumer to personalize their ornamentation utilizing standardized units (one and two sided) in multiple ways by incorporating a method of temporary locking the standardized units in place and at the same time allowing the standardized units to potentially take on multi directional positions. In addition, the standardized units can be personalized without impacting the basic shape which allows them to fit in numerous applications in infinite combinations.

Parts: LifeLinks™ and LifeLink Tiles (one and two sided) are standardized units that can be personalized and worn in a number of ways. The preferred shape is square and can be utilized in multi directions and orientations. The square shape of the LifeLink has openings on 4 sides which allow bracelets and adapters to fit in horizontal and vertical directions increasing the use of a particular design. The LifeLink Tile does not have openings and is shaped to be the central design element of a Clip and Slide Frame.

LifeLink™ Frames (single and double sided) are an additional part of the proposed system which allows the consumer to personalize their ornamentation. They are shaped in a way that allows the standardized LifeLink™ to fit inside and be temporarily secured. They can be incorporated into all types of Jewelry and ornamentation including bracelets, cufflinks, earrings, pendants, Tie Tacks, and other forms of jewelry but not limited to just jewelry.

Another standardized unit of the LifeLinks system is a Frame Frame (single and double sided) which are larger Frames that fit around frames to further embellish the central element. Other standardized units are Spacers (one and two sided) which can be combined with all the other elements to create an unlimited amount of wearable combinations.

An additional aspect to the LifeLink™ system is the adapters which takes any existing LifeLink™ with or without frame and allows the consumer to utilize it in a different way. Adapters may have a connected jump ring on one or both sides to allow the LifeLinks™ and Frames and other accent pieces to be Linked together to make additional ornamentation.

The LifeLink™ system is designed around a locking system that allows you to temporarily lock the modular pieces in place. The preferred method has been rubber or metal correctly sized to fit in the openings that are positioned on all 4 sides of the standardized LifeLink shape, Frames, and Frame Frames. This temporary Locking Method also works when the Frames are incorporated into all ornamentation aspects allowing all personalized LifeLinks™ to securely fit. The bracelet method of locking utilizes a long enough piece of rubber with a catch to fit on the wrist allowing any number of LifeLinks™, Frames, and Spacers to be combined in all types of combination and orientation. Continuous pieces of rubber or silicone can also be used with the modified Clip and Slide versions.

Material: The parts can be made from a variety of materials depending on the price range and purpose of the ornamentation. The preferred material for fine jewelry would include Silver, Gold Plate, different varieties of gold including but not limited to 10 karat, 14 karat, and 18 karat in all the colors that Gold comes in, and Platinum. Other materials include Plastic and Plastic type materials, Base Metal, Ceramic, Wood, Glass, other metals including stainless steel, aluminum, surgical steel, copper, tin, pewter, or any combination of materials, but not limited to the ones mentioned. Any material that can be fashioned into the shape described could be used.

The parts can and may be embellished with different finishes and designs to create interesting, fashionable, and meaningful combinations without affecting the modular nature contained within the system. There is no limit to the amount of embellishment or decorating providing the modular nature remains intact.

Sizes: The parts can be made in different sizes to accommodate the purpose of the ornamentation or use. For each use where the size is adjusted the corresponding parts utilized in the system will also be sized. There is no limit to the size of the modular system provided all of the parts within the system are sized accordingly and fit together as described.

Shapes: The parts can be made in different shapes to accommodate the purpose of the ornamentation. The shapes from one system may be combined with the shapes from another system to create interest or additional variety. There is no limit to the shape of the parts provided the frames and frame frames are designed to fit the shape. The preferred shape is a square. Other good shapes are rectangles, circles, ovals, stars, triangles, pentagons, hexagons, and octagons. All shapes will work provided all the parts within the modular system fit with each other and allow themselves to slide and or clip onto the adapter material and bracelets as described.

Functions beyond design: Another preferred embodiment of the parts could also include functions including but not limited to timepieces, compass, heart monitor, storage device, calendar, blood pressure monitor, pulse monitor, light, flashing light, temperature monitor, medicine applicator, medicine dispenser, nutrition applicator and dispenser, fragrance emitter, or container.

The basic part called a LifeLink and LifeLink Tiles are designed to allow additional ornamentation around them called Frames and then Frame Frames around that. There is no limit to the amount of larger and larger frames that can be added for any specific purpose.

Puzzle Design: An additional aspect of the invention allows several standardized units to be combined so that a single design can cover the entire group. This group can then be separated and worn in several combinations. This method of creating a message or design on a combination of standardized shapes and then separating them allows numerous applications including puzzles, shared information among many, etc. By utilizing two sided LifeLinks™ the ornamentation possibilities are even more numerous. The possibility for various designs and meanings increases when you combine this method with a two sided Frame that can also be positioned in numerous directions and orientations.

### EXAMPLES

### Detailed Descriptions of Drawings

References will now be made in detail to certain preferred embodiments of the invention, examples of which are illustrated in the accompanying drawings. Wherever possible, the same reference numbers will be used throughout the drawings to refer to the same or like parts. It should be understood that these examples are for illustrative purposes only and are not to be construed as limiting this invention in any manner.

Drawing 1 depicts FIG. 1 which is the top (a), bottom (b), sides (c and e), and sides (d and f) of a LifeLink (0), the basic central design element.

Drawing 2 depicts FIG. 2 which is the top (a), bottom (b), sides (c and e), and sides (d and f) of a LifeLink Tile (10) a modified basic central design element combined with frame to complete.

Drawing 3 depicts FIG. 3 which is the top (a), bottom (b), sides (c and e), and sides (d and f) of a LifeLink Clip and Slide (1).

Drawing 4 depicts FIG. 4 which is the top (a), bottom (b), sides (c and e), and sides (d and f) of a LifeLink Clip and Slide Frame (2). The corners (2.1) overlap the frame opening to hold the LifeLink Tile in place. The LifeLink Tile could also be permanently attached if desired.

Drawing 5 depicts FIG. 5 which is the top (a), bottom (b), sides (c and e), and sides (d and f) of a LifeLink Clip and Slide Frame Frame (3).

Drawing 6 depicts FIG. 6 which shows a LifeLink Tile top view (10a) combined with a LifeLink Clip and Slide Frame top view (2a). This makes a LifeLink Clip and Slide Frame with LifeLink Tile (200).

Drawing 7 depicts FIG. 7 which shows a LifeLink Tile top view (10a) combined with a LifeLink Clip and Slide Frame top view (2a), and a LifeLink Clip and Slide Frame Frame top view (3a). This makes a LifeLink Clip and Slide Frame Frame with Frame and LifeLink Tile viewed from the top (300a).

Drawing 8 depicts FIG. 8 which is the top (a), bottom (b), sides (c and e), and sides (d and f) of a LifeLink Spacer (6).

Drawing 9 depicts FIG. 9 which is the top (a), bottom (b), sides (c and e), and sides (d and f) of a LifeLink Clip and Slide Spacer (7). Sides c and e of 7.1 show an alternative version that allows the design to be transformed into other jewelry with the appropriate adapters.

Drawing 10 depicts FIG. 10 which is the top (a), bottom (b), sides (c and e), and sides (d and f) of a LifeLink Clip and Slide Spacer Frame (8). Sides c and e of 8.1 show an alternative version that allows the design to be transformed into other jewelry with the appropriate adapters.

Drawing 11 depicts the top view (a), the jump ring connector (20), the support bar (21a), and supporting base (22) of Figure Charm Adapter (11), Frame Adapter (12), and Frame Frame Adapter (13).

Drawing 12 depicts FIG. 14 Lever Back earring adapter, and FIG. 15 Linker Bail side views (c and e) and front view (a) as attached to an adapter. The Linker tail (25) goes through the adapter's jump ring connector (20) to convert any adapter into a pendant. The Linker hole (26) allows the completed adapter to slide on a necklace, bracelet, or chain. The Lever Back post (23) goes through the adapter's jump ring connector (20) to make an earring as (20) will securely rest in the charm holder portion (24) of the Lever Back (14).

Drawing 13 depicts FIG. 16 rubber (16) or other material that is not continuous and closes with a removable clasp and FIG. 17 rubber (17) or other material that is a continuous circle and does not have a clasp. The top view (a), bottom view (b), side views (c and e) and (d and f) are displayed. The side views (d and f) of FIG. 17 are of a cross section if the material were cut.

Drawing 14 demonstrates how the combination of parts turns into jewelry. FIG. 18 shows a LifeLink (0) on a non continuous bracelet (16). FIG. 19 Shows the same LifeLink (0) as an earring by sliding the charm adapter (11) through the side opening (e) and out (c) allowing the adapter jump ring connector (20) to be attached to Lever Back (14). FIG. 20 Shows the same LifeLink (0) as a pendant by sliding the charm adapter (11) through the side opening (e) and out (c) allowing the adapter jump ring connector (20) to be attached to Linker (15).

Drawing 15 demonstrates how the combination of parts turns into jewelry. FIG. 21 shows a completed LifeLink Clip and Slide Frame (200) on a continuous bracelet (16). It could also fit on a non continuous bracelet (17) by sliding it through sides (d and f) FIG. 22 Shows the same completed LifeLink Clip and Slide Frame (200) as an earring by sliding the Frame adapter (12) through the side opening (e) and out (c) allowing the adapter jump ring connector (20) to be attached to Lever Back (14). FIG. 23 Shows the same completed LifeLink Clip and Slide Frame (200) as a pendant by sliding the Frame adapter (12) through the side opening (e) and out (c) allowing the adapter jump ring connector (20) to be attached to Linker (15).

Drawing 16 demonstrates how the combination of parts turns into jewelry. FIG. 24 shows a completed LifeLink Clip and Slide Frame Frame (300) on a continuous bracelet (16). It could also fit on a non continuous bracelet (17) by sliding it through sides (d and f) FIG. 25 Shows the same completed LifeLink Clip and Slide Frame Frame (300) as an earring by sliding the Frame Frame adapter (13) through the side opening (e) and out (c) allowing the adapter jump ring connector (20) to be attached to Lever Back (14). FIG. 26 Shows the same completed LifeLink Clip and Slide Frame Frame (300) as a pendant by sliding the Frame adapter (13) through the side opening (e) and out (c) allowing the adapter jump ring connector (20) to be attached to Linker (15).

Drawing 17 depicts FIG. 27 which is the top (a), bottom (b), sides (c and e), and sides (d and f) of a LifeLink Frame (2.1) for use with non continuous rubber (16) or other material and FIG. 28 which is the top (a), bottom (b), sides (c and e), and sides (d and f) of a LifeLink Frame Frame (3.1) for use with non continuous rubber (16) or other material.

Drawing 18 depicts FIG. 29 which demonstrates how a LifeLink (0) is modular in design and can rotate to be presented in 4 different directions per side (a and b) as part of any piece of jewelry as demonstrated on a bracelet, earring, and pendant but not limited to only these.

Drawing 19 depicts FIG. 30 which demonstrates how a LifeLink Tile (10) is modular in design and can rotate to be presented in 4 different directions per side (a and b) as part of any piece of jewelry as part of a LifeLink Clip and Slide Frame (2).

Drawing 20 depicts the modular design of FIG. 31 LifeLink Frame (2.1) and FIG. 32 LifeLink Frame Frame (3.1) and shows how they can rotate to be presented in 4 different directions per side (a and b) as part of any piece of jewelry.

Drawing 21 depicts FIG. 33 which demonstrates how a combination of LifeLinks (0) can have a single design and then be separated to be FIG. 34 pieces on a single item or FIG. 35 pieces on 4 individual items. This puzzle dimension of the modular LifeLink (0) also works with the LifeLink Tile (10).

Drawing 22 depicts FIG. 36 and FIG. 37 which demonstrates all views of a wide cross (27) and thin cross (28) that still fits on a continuous bracelet (17a) and can also be transformed into other wearable versions utilizing the adapters (121 with 14 or 15).

Drawing 23 depicts FIG. 38 which shows a 3 dimensional view of 3a, 2a, and 10a combined to be 300. 300 with 15 and 12 becomes a pendant. 300 with 17a becomes a bracelet.

The invention claimed is:

1. Modular jewelry and ornamentation comprising: a basic central design element having one or two design sides, a frame, single or double sided, that goes around the first element to further embellish it, a frame frame, single or double sided, that goes around the second element to further embellish it, any additional number of progressively larger modular embellishing frames, all elements having openings on horizontal and vertical sides to allow a series of adapters to slide through the individual or any combination of the described elements in either direction to temporarily secure them together in multiple combinations, and accessory adapters that transform the combined items into different forms of wearable and useable ornamentation.

2. The modular jewelry and ornamentation described in claim 1 wherein the materials are traditional jewelry materials including but not limited to silver, gold, platinum, gold plated, pewter, copper, stainless steel, surgical steel, and other materials including but not limited to plastic, rubber, glass, wood, and ceramic and any combination of materials.

3. The modular jewelry and ornamentation described in claim 1 adorned with raised designs, engraved designs, painted designs, gemstones, enamel, and other forms of decoration.

4. The modular jewelry and ornamentation described in claim 1 where the surface designs are meaningful.

5. The modular jewelry and ornamentation described in claim 1 where the items can be clipped onto a continuous band and still work with the adapters and adapter accessories described in the invention.

6. The modular jewelry and ornamentation described in claim 1 where the basic central design element and or frames could have a functional utility including but not limited to timepieces, compass, mp3 player, communication device, GPS, cell phone, digital wallet, storage devise, computer, vital sign monitor, light, flashing light, thermometer, medicine applicator, nutrition applicator, fragrance container, fragrance dispenser, and signal producer.

7. The modular jewelry and ornamentation described in claim 1 whereby multiple basic central design elements and or frames can be combined in the decoration phase to wear or used in a separate way so that pieces of the “puzzle” can be shared or worn in a separated format.

8. The modular jewelry and ornamentation described whereby they are marketed in combinable sets with the idea that the combination of the parts leads to a maximization of wear-ability and a minimization of cost.
